(19) United States
(12) Patent Application Publication
(10) Pub. No.: US 2002/0033837 A1
(43) Pub. Date: Mar. 21, 2002

(54) Multiple-image viewer

(76) Inventor: James A. Munro, Santa Cruz, CA (US)

Correspondence Address: Thomas S. Ferrill, BLAKELY, SOKOLOFF, TAYLOR & ZAFMAN LLP, 12400 Wilshire Boulevard, 7th Floor, Los Angeles, CA, 90025, US

(21) Appl. No.: 09/757,561

(22) Filed: Jan. 9, 2001

Related U.S. Application Data
(60) Provisional application No. 60/175,303, filed on Jan. 10, 2000.

(51) Int. Cl. G09G 5/00

(52) U.S. Cl. 345/654

(57) ABSTRACT

A method, apparatus, and system in which a multiple-image viewer concurrently displays and manipulates multiple images within a single window in a network system. One or more of the display images are a raster graphic file. Each of the display images has a separate data file.

### BACKGROUND OF THE INVENTION

Today, many people access images from the Internet for a variety reasons. For example, when shopping over the Internet, shoppers have two desires. Shoppers want to see images of what they are buying. Shoppers want to see these images in real time.

When images are being displayed using a web browser, a page description language, such as, for example eXtensible Markup Language (XML) or Hyper Text Markup Language (HTML), defines how to display these images. The standard HTML language allows images of various types, such as, for example, raster graphics and vector graphics, to be inserted into a web page using the HTML tag ‘IMG’. Images from raster graphic files do compress but generally not efficiently with current compression technologies. Traditionally, access to view such images over the web is slow or takes up considerable bandwidth. Traditionally, shoppers do not generally wait for slow web pages to download.

Shoppers also like to compare and manipulate images of products that they are considering buying. Flashpix is one implementation that allows people to view and manipulate an image by zooming in on the image. Live Picture and others use Internet Imaging Protocol (IIP) to manipulate an image in the window. However, these implementations are not useful for manipulation of multiple images displayed in a single window. Currently, an Internet shopper is inhibited from displaying and manipulating multiple images of competing products in a single window.

In most client-server systems for viewing or browsing different types of content, when an image is displayed, the underlying system reserves a rectangular area on the screen in which the image is displayed. In the case of a typical web page written in HTML, when the browser encounters an image, the browser creates a window in which the image is displayed. Usually, the browser creates the window, and then the image software decodes and displays the image into the window. In the case of no-standard, or non embedded image types, the browser software creates a window for the image, and then passes control to a software ‘plug-in’ which decodes and displays the image in the window. Most web browsers can display images directly even when they are not embedded in an HTML or other document. In this case, the browser allocates the entire browser window as the image window. However, whether the viewing application is a web browser, or a Java application (applet), the concept of an image ‘window’ is universal and each allocated window space is generally occupied by a single image.

Today, images may be displayed over a network within a window in a variety of ways. Multiple images with each image in its own window, usually an array of thumbnails, may be displayed together within a single overall browser window. A composition of multiple images may be put together into a single image file and that sole image file will be displayed within a single window. In video applications, a display of a sequence of multiple images occurring one at a time takes place in a single window. Yet none of these applications allow for two separate images, each image having an independent data file, to be concurrently displayed and manipulated in the same window.

### SUMMARY OF THE INVENTION

A method, apparatus, and system in which a multiple-image viewer concurrently displays and manipulates multiple images within a single window in a network system. One or more of the displayed images are a raster graphic file. Each of the displayed images has a separate data file.

### BRIEF DESCRIPTION OF THE DRAWINGS

The drawings refer to the invention in which:

FIG. 1 illustrates an embodiment of a client-server system using the multiple-image viewer;

FIG. 2 illustrates an exemplary web page using an embodiment of the multiple-image viewer to display four images and the content associated with those images;

FIG. 3 illustrates the third image of FIG. 2 magnified by an embodiment of the multiple-image viewer;

FIG. 4 illustrates the independent nature of each image file within the window;

FIG. 5 illustrates that the entirety of the window space is available for any images displayed within that window and that the images may overlay one another.;

FIG. 6 illustrates the first through fourth image as shown in FIG. 2; however, the user has selected a region of interest and zoomed in on a majority of the third image and small portions of the first image, the second image and the fourth image;

FIG. 7 illustrates an embodiment of the multiple-image viewer displaying a wine bottle image and a hierarchical system of folders containing content associated with that wine bottle image;

FIG. 8 illustrates the corresponding size of the data file associated with each level of resolution of a displayed image; and

FIG. 9 illustrates an embodiment of a multiple-image viewer implemented as a program containing various modules.

While the invention is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the invention.

### DETAILED DISCUSSION

A multiple-image viewer is described. In the following description, numerous details are set forth, such as specific controls to manipulate an image, specific methods to calculate a predetermined setting, etc. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as data bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The multiple-image viewer also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the multiple-image viewer is not described with reference to any particular programming language. It will be appreciated that a variety of programming languages may be used to implement the teachings of the invention as described herein.

### OVERVIEW

In an embodiment, a multiple-image viewer system is described that may display and/or manipulate multiple images in a single window, such as a browser window or plug-in window. In an embodiment, the window of the multiple-image viewer may be the viewing area or display area reserved for the purpose of displaying one or more images and any content associated with those images. The top-level of the window may be the plug-in display window. Image file and compression technology supports the multiple-image viewer. Although at least one image file and compression technology are described herein, it would be apparent to those skilled in the art to employ other image file structures and/or different compression technologies.

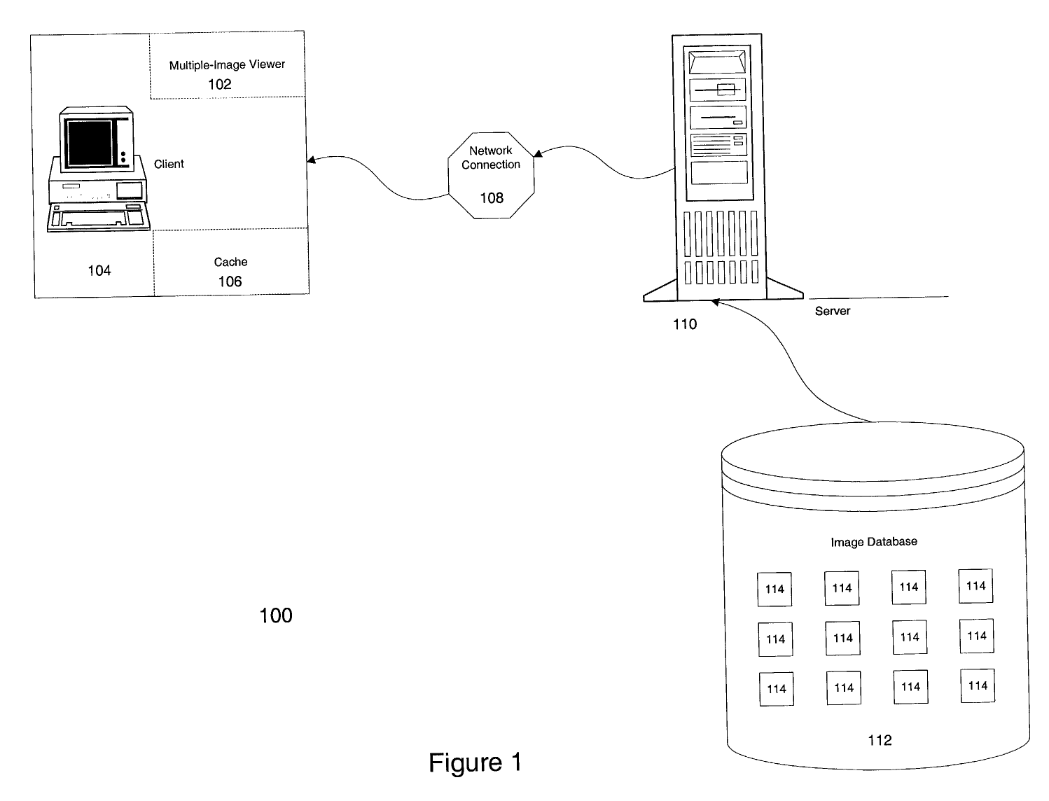

FIG. 1 illustrates an embodiment of a client-server system 100 using the multiple-image viewer 102. The client-server system comprises a client 104 having a cache 106 and an embodiment of the multiple-image viewer 102, a network connection 108, a server 110, and an image database 112 associated with the server 110. In an embodiment, the client 104 may be a personal computer or other similar device. In an embodiment, the network connection 108 may be a digital subscriber line connection, a T-I connection, a local area network connection, an Internet server provider connection, wireless connection, or other similar network connection. In an embodiment, a network may be a client server system, a World Wide Web, an Internet, a mobile phone network, a first device in communication with a second device, such as a computer in communication with a first personal digital assistant (PDA), a first PDA in communication with a second PDA, or a PDA in communication with an intelligent phone, or any other similar system. In an embodiment, the multiple-image viewer 102 instructs the client 104 to request image data 114 from the image database 112 via the server 110. In one embodiment, multiple-image viewer 102 displays and enables manipulation of multiple images through the use of a web-based application. The multiple-image viewer 102 may be integrated into a browser, a plug-in, an Active-x control, a Java applet, or another similar program. The browser may be a readily available Internet web browser software product (e.g., a browser available from Netscape, Internet Explorer, a Java-implemented browser, etc.). In an alternate embodiment, the browser may be implemented as a stand-alone Java applet or an Active-X control. In one embodiment, the browser allows functionality to be extended by plug-ins. Thus, the plug-in extends the browser's architecture to allow the images to be displayed in the window.

In one embodiment, the image database 112 associated with the server 110 stores images. Each of the images may have a separate image data file 114. The image data file 114 may be stored in a compressed format. In one embodiment, the image data file 114 is compressed according to a block-based integer wavelet transform entropy-coding scheme.

In one embodiment, the multiple-image viewer 102 uses the standard HTML language to insert images into web pages. In one embodiment, in this case, the images are inserted into the window using the HTML ‘EMBED’ tag. That is, in one embodiment, the HTML syntax is an extension to the existing EMBED tag. Using features of the HTML language, the size and position of the image window can be controlled. In an embodiment, the viewer uses another Extended Markup Language, PIXML, to insert images into a web page. An embodiment of the PIXML is attached to this description and incorporated herein. In another embodiment, the multiple-image viewer may use XML or another similar page description language to insert images into a page.

In an embodiment, the browser creates a window for the multiple-image viewer 102 and obtains the data associated with the multiple-image viewer 102. The browser then relinquishes control to the multiple-image viewer 102, which decodes image data 114 and displays the images in the window. Thus, the multiple-image viewer 102 decodes and displays multiple images within a single plug-in window.

By extending the functionality of a plug-in window in this way, the multiple-image viewer 102 is able to perform operations on these images, either as a group or as individuals. For example, the user can visually zoom in or out on a group of images. In one embodiment, to facilitate these operations, each image may have its own specific hypertext links, image map, or other attributes to allow the images to be manipulated independently.

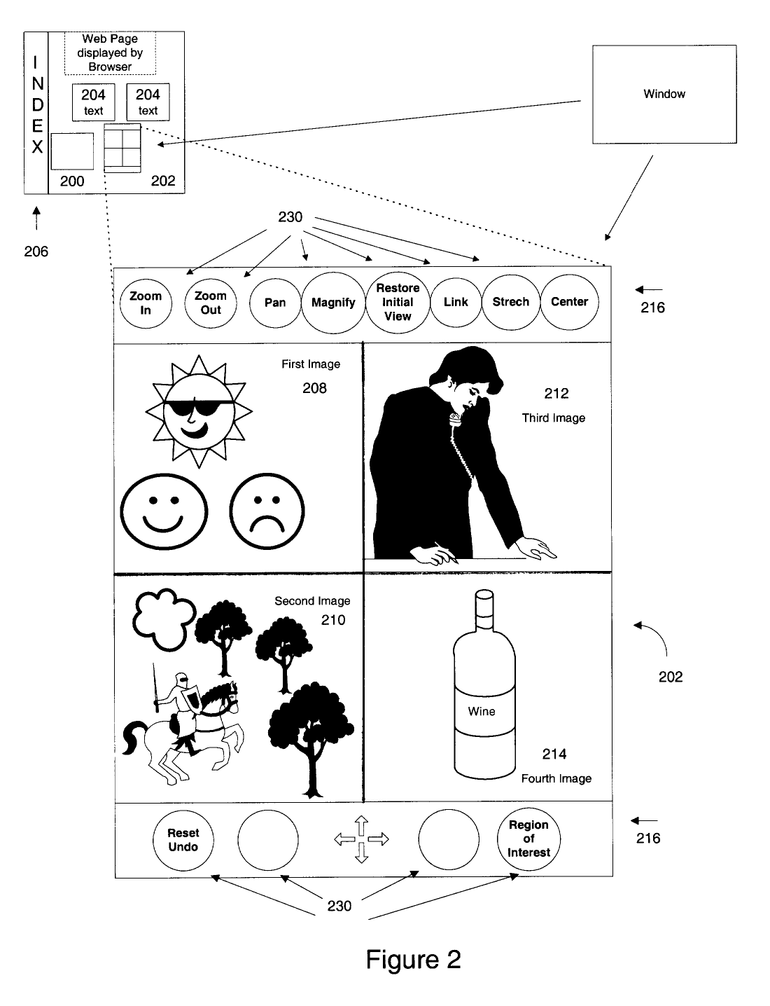

FIG. 2 illustrates a web page 200 using an embodiment of the multiple-image viewer to display four images and the content associated with those images. In one embodiment, a browser displays the web page 200. The web page 200 or page file contains two text documents 204, an index 206 with hypertext links, and a window 202 created by an embodiment of the multiple-image viewer. The window 202 contains four images; first image 208, a second image 210, a third image 212, and a fourth image 214. The window also has two navigation tool bars 216 with numerous controls 230 to manipulate these images. The first image 208 displayed by the viewer is a digital image of an oil painting of a sun over two smiley faces. The second image 210 is of a knight riding a horse through a wooded countryside. The third image 212 is a digital photograph of a woman talking on the phone. The fourth image 214 is a bottle of wine. In one embodiment, the navigation tool bars 216 contain the following controls 230 to manipulate each image. The user may manipulate each of the displayed multiple images by zooming in on the image, zooming out from the image, selecting a region of interest in the image, restoring the default or initial view of the image, panning the image, linking to the image, stretching the entire image, centering the image in the window, resetting/undoing the last operation performed on the image, magnifying the image, moving left on the image, moving right on the image, moving up on the image, or moving down on the image. In another embodiment, the multiple-image viewer may manipulate a displayed image by using the controls 230 mentioned above as well as other similar controls.

The manipulation controls 230 from the navigation tool bar 216 may be implemented in the client. As noted above, the user can use the set of controls 230 to zoom in/out or to pan across the images. By zooming or panning, the user causes the multiple-image viewer to calculate new parameters and then make the appropriate request for data (e.g., blocks of data) to the server. When the user zooms in on the images, the multiple-image viewer calculates the new geometric coordinates for the new view. Based on the location of the cursor, the multiple-image viewer calculates which part of the image(s) will appear in the window 202 and then obtains the appropriate data. Based on this determination, the client makes a simple request to the server and the server responds with the appropriate block(s) of data. Using the data, the multiple-image viewer calculates where in the window 202 each part of each image is to appear. For multiple images, this process is repeated for each image in the window 202. Note, the images are shown in a regular array, i.e., the images are evenly spaced between each other and arranged in a linear manner. The images in the window 202 may also be located as an irregular array to allow each image to have different size dimension and even overlay on top of another image.

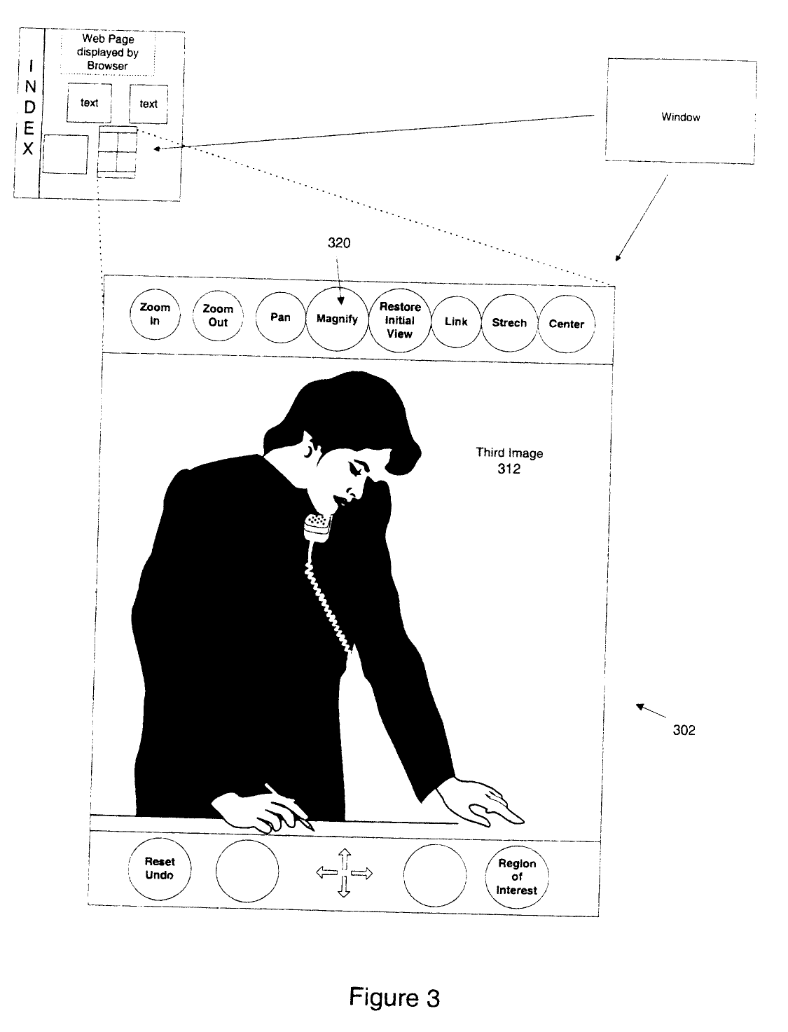

FIG. 3 illustrates the third image of FIG. 2 magnified by an embodiment of the multiple-image viewer. A user has employed a control 320 of the multiple-image viewer to magnify the third image 312 displayed in the window 302. The third image 312 has increased in viewing area to occupy the entire window 302.

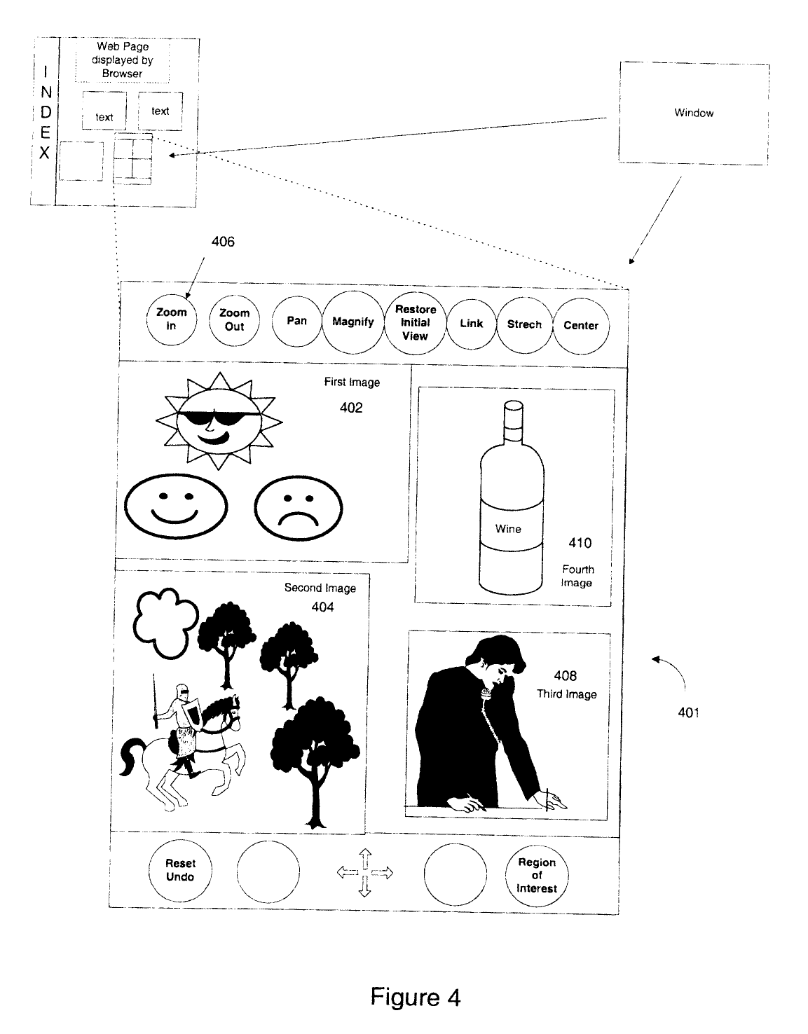

FIG. 4 illustrates the independent nature of each image file within this window. Each displayed image has a separate and independent data file. Thus, an end user may manipulate each image independently in almost any manner the end user chooses. The first image 402 of the sun and the smiley faces has been stretched. Thus, the displayed sun and the displayed smiley faces are slightly distorted in the lateral direction. The second image 404 has been zoomed-in 406 on. Thus, the display sizes of the knight and the countryside have increased within the window 401. The third image 408 has been condensed and moved to occupy a partial amount of the space where the fourth image 410 was located. The fourth image 410 has been condensed and moved to occupy a partial amount of the space where the third image 408 was located.

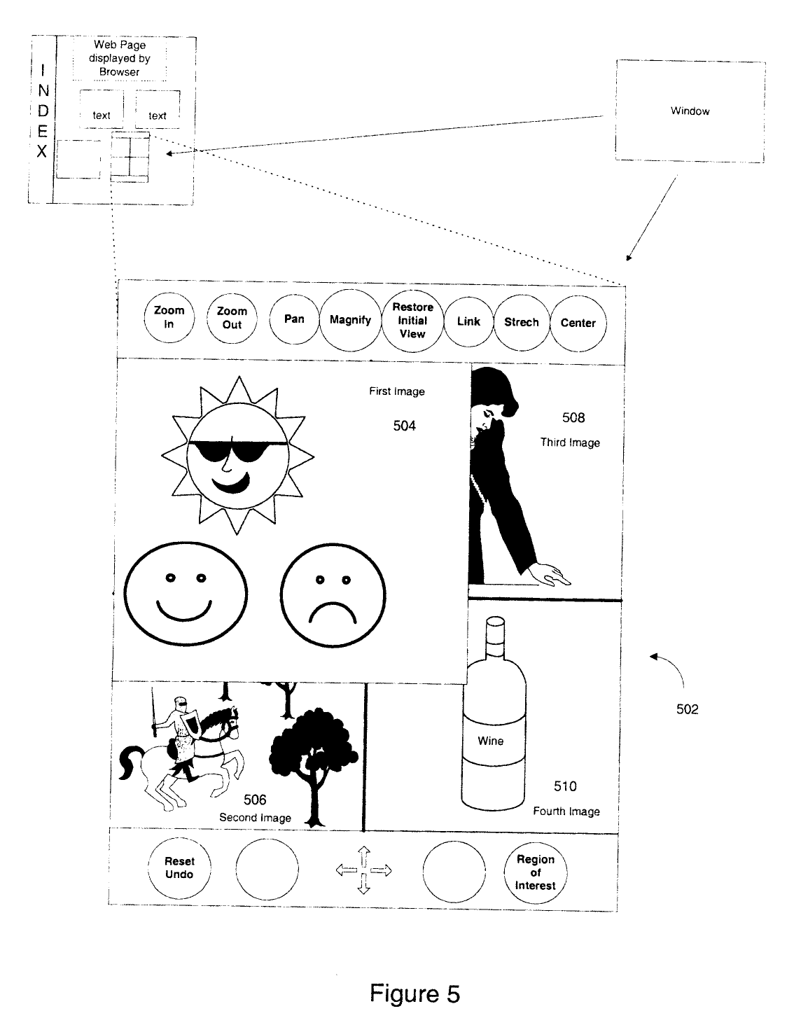

FIG. 5 illustrates that the entirety of the window space is available for any images displayed within that window and that the images may overlay one another. The first image 504 has been manipulated to be increased in display size within the window 502. The display of the first image 504 now overlays portions of the second image 506, the third image 508, and the fourth image 510. The window 502 is an area reserved to display one or more images. Any one of the displayed images may occupy part of the window 502 or the entirety of the window 502

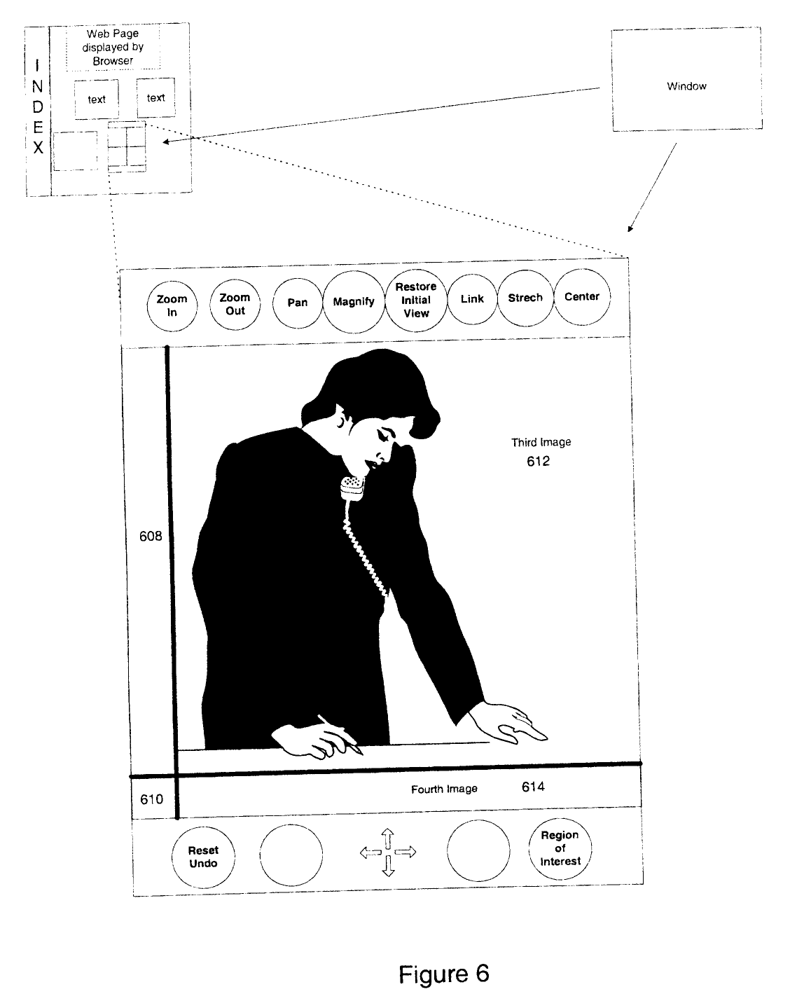

FIG. 6 illustrates the first through fourth image as shown in FIG. 2; however, the user has selected a region of interest and zoomed in on a majority of the third image and small portions of the first image, the second image and the fourth image. The viewer displays a majority of the third image 612, a woman speaking on a telephone, and only small portions of the first image 608, the second image 610 and the fourth image 614.

In one embodiment, the multiple-image viewer constantly keeps track of which data it already has so that it does not have to request the same data multiple times from the server. In one embodiment, the multiple-image viewer keeps track of what is in the window and also what other data is in the cache. A pixel-to-pixel mapping exists between the image and the window, so depending on resolution level, window size, and image position within (or without) the window, the client performs the geometric calculations.

In one embodiment, in the case of zooming, panning, or moving, when the proper data to fill in a new part of an image displayed in the window is not available, then the data is scaled from the previous resolution level and used immediately. When the proper data arrives from the server, the data is decoded and displayed. Thus, when the user moves, pans, or zooms, an immediate visual result occurs with the quality of the image improving as data arrives.

In one embodiment, the request for data is performed using a HTTP ‘GET’ command that specifies the URL of each image, which resolution level, and which blocks of data are required based on, for example, resolution level. In an embodiment, the default is to obtain the entire full size image. In one embodiment, the multiple-image viewer only requests image data for those images or parts of images, which actually appear in the plug-in window. Images or parts of images that are outside the visible plugin window are not requested to preserve bandwidth. Note if the multiple-image viewer requests data for two or more of the images, then the image date files may be on different sites.

In one embodiment, all data received from the server is cached locally and reused wherever possible. Caching data locally allows random access to different parts of the image and allows images, or parts of images, to be loaded in a variety of resolution and quality levels. In one embodiment, the multiple-image viewer reuses the existing image data together with the new image data to create a high quality higher resolution view. Thus, the multiple-image viewer uses a file hierarchy that allows for two resolution levels to be extracted from one sub-image. In an alternative embodiment, the client initially downloads all the images. At which point, the multiple-image viewer only decodes that portion of each image that is to appear in the window. In an embodiment, the multiple-image viewer requests and decodes the amount of data corresponding to an actual area of the image to be displayed, blocks of data surrounding that area to be displayed, and data for one level of higher resolution of the image being displayed.

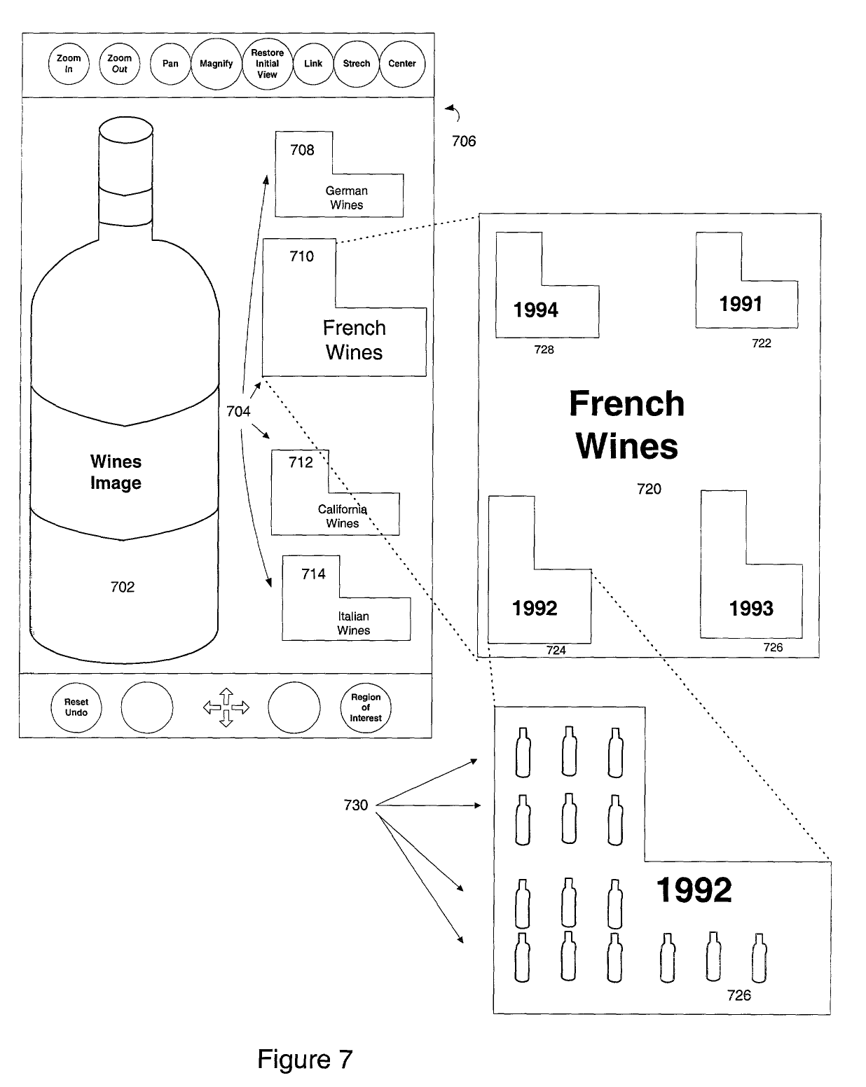

FIG. 7 illustrates an embodiment of the multiple-image viewer displaying a wine bottle image 702 and a hierarchical system of folders 704 containing content associated with that wine bottle image 702. The window 706 displays the wine bottle image 702 and four icons, a German wine icon 708, a French wine icon 710, an Italian wine icon 714, and a California wine icon 712. In one embodiment, a hierarchical folder such as a parent folder contains the image of the wine bottle 702 and four subfolders 708, 710, 712, 714, represented by the icons. In another embodiment, the image of the wine bottle 702 is separate from each folder represented by an icon and each folder represented by an icon is distinct from every other folder. The author of the web page may determine how to arrange these items that appear in the window 706, such as images, folders, and content within either the image or the folder. However to the user, the window 706 appears to be displaying the same picture.

The multiple-image viewer allows for images to be comprised of a hierarchical system of folders 704. The multiple-image viewer uses two basic objects an image and a folder. A folder is a container that can hold, and thus display, one or more images. An image may be a raster graphic (i.e. natural bitmap image) or other similar file. A raster graphic differs from a vector graphics in the way that a computer interprets the image data file. A vector graphic defines a picture as points, lines and other geometric entities. The points, lines and other geometric entities generally define an object. The combination of all the individual objects usually creates the vector graphics image. A raster graphic represents a picture image as a matrix of dots known as pixels. The computer generally views the combination of all of the pixels to comprise the image. Dozens of raster (natural bitmapped) graphics formats exist, including GIF, TIF, BMP, JPG and PCX. The image may be encoded with compression technology and with multi-resolution random access capability. Both a folder and an image can have other content associated with them. Both images and folders can contain content such as images, graphics objects, sub folders, tiled and non-tiled background images, a text document, a hyperlink, an image map, an image address or other similar content. In an embodiment, each folder may be represented in XML by a <PIXML> tag.

Both images and folders have a variety of attributes that include a flexible way of defining behaviors such as zooming or moving objects. The multi image viewer also supports an event manager that enables external user code to respond to events that occur within the system. Graphic objects include basic 2-D vector graphics functions such as text, lines, and circles. Images can be placed in separate layers; the upper layer will overlay the lower one when there is an overlap. Each image can also have a hypertext link so that the user can click on a specific image and cause the browser to go to a new location in the image. In addition to being able to display a folder as an image, a web page author may also use an icon, thumbnail, or other similar structure to visually represent the folder.

In one embodiment, the multiple-image viewer displays an icon representing either an image, a folder, the content within the folder, or the content within the image, if the level of the image is below the value of a predetermined setting. Similarly, the multiple-image viewer displays the image, the folder, the content itself, if the level of the image is above the value of a predetermined setting. Thus in this illustration, if a user zooms in on the folder represented by a French wine icon 710, then a French wine subfolder 720 opens up to reveal four more subfolders, a year 1991 subfolder 722, a year 1992 subfolder 724, a year 1993 subfolder 726, and a year 1994 subfolder 728. If the user zooms in on the icon representing the 1992 subfolder 724, then another subfolder 726 opens up to reveal numerous wine bottle icons 730 labeled with the types and manufacturer of the actual 1992 wines that the user may purchase, for example. If the user enlarges a specific wine bottle icon 730 above the predetermined setting, then a full image of the specific wine will be displayed in the window 706. In another embodiment, the content will be hidden within the image if the level of the images is below a predetermined setting. As described herein, in an embodiment the multiple-image viewer only downloads the data for the images, folders, and subfolders actually displayed. Thus, when the user requests another subfolder to open up, then the viewer downloads those corresponding blocks of data.

The multiple-image viewer may use a variety of methods to establish the value of the predetermined setting for displaying or not displaying an image, an icon, or content. The predetermined setting may be selected from one of the following: a level of zoom, a predetermined resolution level, a preset size of the image or folder to the viewing area, a percentage of the full sized original image, a display level, or a similar mathematical arrangement. In an embodiment, when an object, an image or a folder is displayed, the level of the object is combined with the level of the parent folder, and the levels of all the parent folders to compute a display level for display purposes. The viewer may compare the display level to a root level to determine whether or not the value is above or below the value for the predetermined setting. In an embodiment, the author of the web page determines the value for the predetermined setting. In general, “zoom in” will reduce the level of the root folder by 1 and “zoom out” will increase the root folder level by 1. Zoom in and zoom out functions can also be defined by attribute values that can be integer resolution levels, percentages, or ‘fit’, where the zoom operation matches the resolution of the object(s) to the parent folder.

In an embodiment, the value of the predetermined setting is assigned to a “display level” attribute. The “display level” attribute is used to determine whether a folder is displayed as an image, a folder icon, not displayed, or whether the contents of the folder or image are contain within the object. In an embodiment, going above the predetermined setting causes a client to request more data, such as the entire data file for the image and any content within the image, from the server.

In an embodiment, below the value of the predetermined setting, the client downloads a limited amount of data regarding the content within the image and above the value of the predetermined setting; the client downloads the entire data file for the content. In an embodiment, the viewer requests and decodes the amount of data pertaining to the actual area of the image to be displayed, blocks of data surrounding that area to be displayed, and one level of higher resolution of image being displayed.

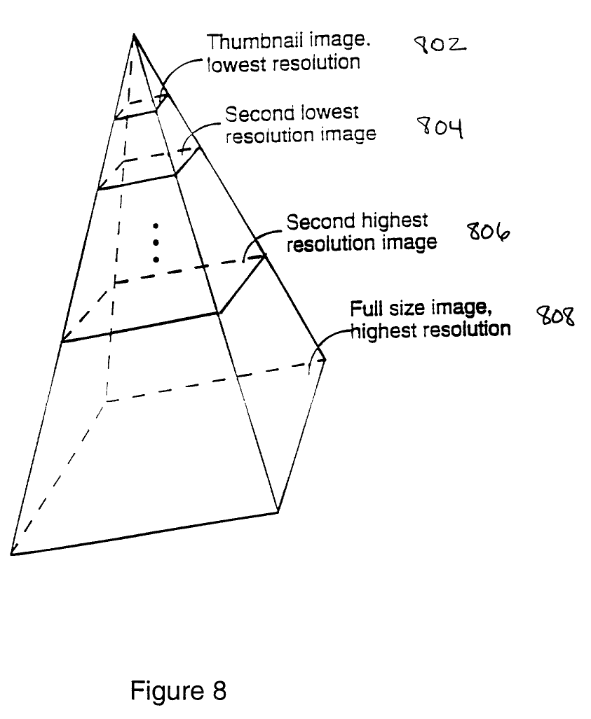

FIG. 8 illustrates the corresponding size of the data file associated with each level of resolution of a displayed image. The multiple-image viewer supports displaying images having multiple levels of resolution. In an embodiment, an image may have four levels of resolution. The thumbnail image or icon image 802 has the lowest resolution level and the least amount of data in its corresponding image data file. The second resolution level 804 and the second highest resolution level 806 each have a progressively higher resolution level for the image and a greater amount of data in their corresponding image data file. The fourth resolution level or full size image 808 resolution is the highest resolution level and contains the greatest amount of data. If for example the user zooms in on an image above the predetermined setting, then the multiple-image viewer would request the next higher resolution level of the image. The multiple-image viewer also allows arranging multiple images and graphics at different resolution levels, in the same window. An embodiment of a file structure along with multi-resolution compressed image management is described in U.S. Pat. No.6,041,143, entitled “Multiresolution Compressed Image Management System and Method” issued Mar. 21, 2000. An embodiment for transforming, quantizing, encoding, and/or building a resolution hierarchy which enables efficient coding at all levels of resolutions is described in U.S. patent application Ser. No. 09/687,467, entitled “Multiresolution Image Data Management System and Method based on tiled wavelet_like transform and sparse data encoding,” filed Oct. 12, 2000 assigned to the corporate assignee of the present invention and incorporated herein by reference.

The compressed images are stored in a file structure. In one embodiment, the file structure comprises of a series of sub-images, each one being a predetermined portion of the size of its predecessor (e.g., 1/16 of the size of its predecessor). In one embodiment, each sub-picture is made up of a series of blocks that each contains the data associated with a 64×64 pixel block. That is, each image is divided into smaller individual blocks, which are 64×64 pixels. Each block contains data for decoding the 64×64 block and information that can be used for extracting the data for a smaller 32×32 block. Accordingly, each sub-image contains two separate resolutions. When the image is compressed, the bit-stream is organized around these 64×64 blocks and server software extracts a variety of resolution and/or quality levels from each of these blocks. The viewer stores in the cache the blocks of data for the image and areas substantially surrounding the displayed area

The server sends the client a portion of the file that includes parameters that detail image size (e.g., height and width), size of window resolution level, which blocks to decode, and the number of sub-pictures that are contained in the file. Initially, the images that are displayed in the window are set by the HTML tags or, in their absence, by default values.

In one embodiment, when the browser hands over control to the client side plug-in, the multiple-image viewer receives a set of parameters associated with the EMBED tag. These parameters include a list of image addresses, together with a set of parameters for each image that include image size, initial resolution level, and whether the image has a border. The plug-in parameters can specify which part of an image to load by defining a rectangular set of blocks. The default is the entire image. The plug-in makes the appropriate requests for data from the server side using standard HTTP protocols and then displays the set of images within the window. The multiple-image viewer automatically determines which blocks are within the window and only requests and decodes those blocks of data.

As noted above, in one embodiment, the images are compressed according to a block-based integer wavelet transform entropy coding scheme. For more information on one embodiment of the transform, see U.S. Pat. No. 5,909,518, entitled “System and Method for Performing Wavelet-Like and Inverse Wavelet-Like Transformation of Digital Data,” issued Jun. 1, 1999. One embodiment of a block-based transform is described in U.S. application Ser. No. 60/094,129, entitled “Memory Saving Wavelet-Like Image Transform System and Method for Digital Camera and Other Memory Conservative Applications,” filed Jul. 22, 1999. One embodiment of scalable coding is described in U.S. patent application Ser. No. 5,949,911, entitled “System and Method for Scalable Coding of Sparse Data Sets,” issued Sep. 7, 1999. One embodiment of block based coding is described in U.S. Pat. No. 5,886,651, entitled “System and Method for Nested Split Coding of Sparse Data Sets,” issued Mar. 23, 1999. Each of these are assigned to the corporate assignee of the present invention and incorporated herein by reference.

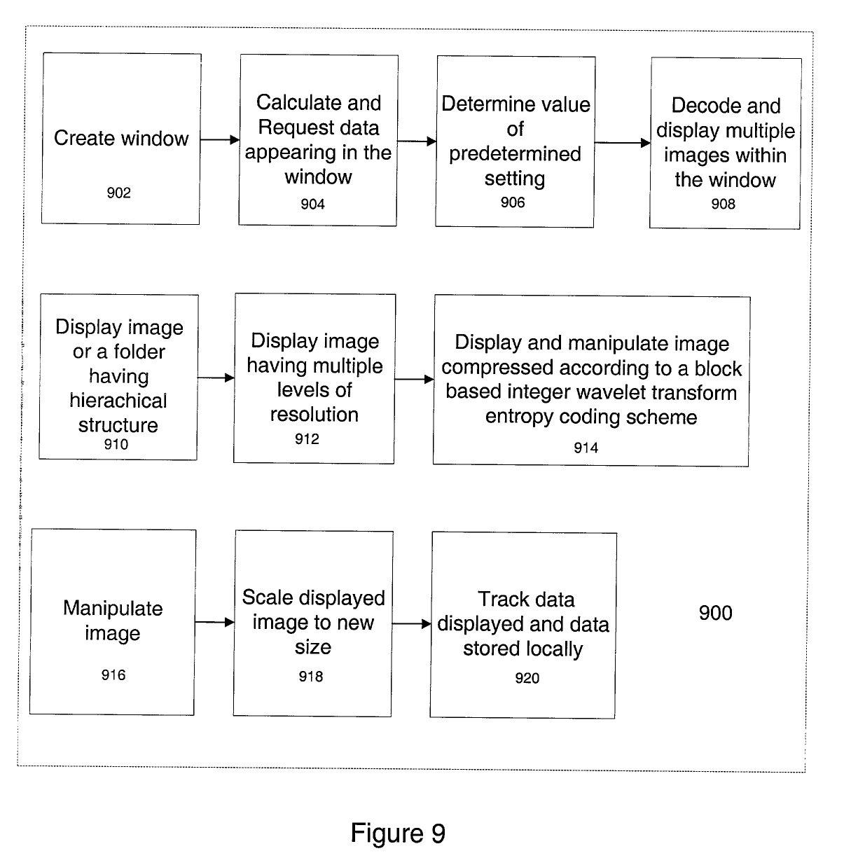

FIG. 9 illustrates an embodiment of a multiple-image viewer implemented as a program containing various modules. In an embodiment, the multiple-image viewer comprises a web-based program 900 consisting of the following modules to perform all of the functions previously described herein. A first module 902 exists to create a window defined by a page description language. A second module 904 exists to calculate the data to appear in the window and to request from a server data to appear in the window. A third module 906 exists to determine the value for the predetermined setting. A fourth module 908 exists to decode and display multiple images within the window. A fifth module 910 exists to display one or more images having a hierarchical structure and/or one or more folders having a hierarchical structure. A sixth module 912 exists to display one or more images having multiple levels of resolution. A seventh module 914 to display and manipulate one or more images compressed according to a block based integer wavelet transform entropy coding scheme. An eighth module 916 exists to enable controls for the manipulation of one or more images. A ninth module 918 to scale a displayed image to new size. A tenth module 920 to track the data being displayed in the window and to track what data is currently stored locally in the cache. In an embodiment, a computer program or another similar program directs and controls the operation of the multiple-image viewer. The computer program is comprised of a number of modules to perform all of the functions previously described herein.

An embodiment of a multiple-image viewer, implemented as a program, can be embodied onto a machine-readable medium. A machine-readable medium includes any mechanism that provides (e.g., stores and/or transmits) information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.); etc.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. An apparatus, comprising:
a multiple-image viewer to concurrently display multiple images within a single window in a network system, the viewer enabling manipulation of a displayed image, the displayed image being a raster graphics file, each of the displayed images having a separate data file.

2. The apparatus of claim 1, wherein manipulation of the displayed image is one in a group consisting of zooming in on the displayed image, zooming out from the displayed image, selecting a region of interest of the displayed image, restoring an initial view of the displayed image, panning the displayed image, linking to the displayed image, stretching the displayed image, centering the displayed image in the window, resetting/undoing an operation performed on the displayed image, magnifying the displayed image, moving left on the displayed image, moving right on the displayed image, moving up on the displayed image, or moving down on the displayed image.

3. The apparatus of claim 1, wherein the multiple-image viewer comprises a web-based application.

4. The apparatus of claim 3, wherein the web-based application is one in a group consisting of a browser, a Java applet, an Active-X control, or a plug-in.

5. The apparatus of claim 1, wherein the window is one in a group consisting of a plug in window or a browser window.

6. The apparatus of claim 1, wherein the window comprises a viewing area defined by a page description language.

7. The apparatus of claim 1, wherein the multiple-image viewer comprises a computer readable medium containing a program to concurrently display and manipulate multiple images within a single window in a network system.

8. The apparatus of claim 1, wherein the network system is one in a group of a client server system, a World Wide Web, an Internet, a mobile phone network, a first device in communication with a second device.

9. The apparatus of claim 1, wherein the displayed image comprises a folder having a hierarchical structure.

10. The apparatus of claim 1, wherein the displayed image further comprises an attribute for multi-resolution capability.

11. The apparatus of claim 1, wherein the multiple-image viewer manipulates the displayed images either as a group or individually.

12. The apparatus of claim 1, wherein the multiple-image viewer further comprises a module to calculate which part of the displayed image that will appear in the window and then to request data that corresponds to the part of the displayed image that will appear in the window.

13. The apparatus of claim 1, wherein the multiple-image viewer further comprises a module to calculate one or more geometric coordinates of a portion of the displayed image to appear in the window, and then to request blocks data for the portion of the displayed image to appear in the window.

14. The apparatus of claim 1, wherein the multiple-image viewer further comprises a module to display multiple images at different resolution levels.

15. The apparatus of claim 1, wherein the displayed image comprises an image having a hierarchical structure.

16. The apparatus of claim 1, wherein the multiple-image viewer further comprises a module to display and manipulate a folder having a hierarchical structure.

17. The apparatus of claim 1, wherein the multiple-image viewer further comprises a module to display and manipulate an image compressed according to a block based integer wavelet transform entropy coding scheme.

18. The apparatus of claim 1, wherein the multiple-image viewer further comprises a module to decode and to display multiple images within the window.

19. The apparatus of claim 1, wherein the multiple-image viewer further comprises a module to keep track of the data being displayed in the window and the data being stored locally in a cache.

20. The apparatus of claim 1, wherein the multiple-image viewer further comprises a module to scale the displayed image to a new size with data stored in a cache until the multiple-image viewer decodes data corresponding to the new size from a server.

21. The apparatus of claim 1, wherein the multiple-image viewer further comprises a module to request data for only the displayed image or a part of the image that is actually to appear in the window.

22. The apparatus of claim 1, wherein the multiple-image viewer further comprises a module to request all data pertaining to the displayed image but only to decode a portion of the data corresponding to a part of the displayed image which is actually to appear in the window.

23. The apparatus of claim 1, wherein the multiple-image viewer further comprises a module to request and decode an amount of data corresponding to an actual area of an image to be displayed, blocks of data surrounding that area of the image to be displayed, and data for one level of higher resolution of the image being displayed.

24. The apparatus of claim 15, wherein the image having the hierarchical structure comprises the image having a folder, the folder having content, and the content being within the folder.

25. The apparatus of claim 15, wherein the image having the hierarchical structure comprises an image having content, the content being within the image.

26. The apparatus of claim 24, wherein content is one in a group consisting of a subfolder, a graphic object, a text document, a hyperlink, a border information, an image map, or an image address.

27. The apparatus of claim 1, further comprising a predetermined setting to cause a client to request more data for the displayed image appearing in the window.

28. The apparatus of claim 27, wherein the predetermined setting is one in a group consisting of a level of zoom, a predetermined resolution level, a size of the image, a percentage of a full sized original image, or a display level.

29. The apparatus of claim 27, wherein the predetermined setting comprising a value set at the time of the creation of the webpage.

30. The apparatus of claim 27, further comprising the predetermined setting having a value, below the value of the predetermined setting a representation of an object is displayed and above the value of the predetermined setting the object is displayed.

31. The apparatus of claim 30, wherein the object is one in a group consisting of the displayed image, a folder, content associated with the displayed image, or content associated with the folder.

32. The apparatus of claim 27, further comprising the predetermined setting having a value, below the value of the predetermined setting an object is not displayed and above the value of the predetermined setting the object is displayed.

33. A computer system, comprising:
a client having a memory;
a computer program to manipulate and to display multiple images within a single window, the program executable by the client, one or more of the multiple images being a raster graphics file, each of the displayed images having a separate data file;
a network connection; and
an image database associated with a server.

34. The computer system of claim 33, wherein the program further comprises a module to display and to manipulate one or more of the multiple images, at least one of the multiple images having a hierarchical structure.

35. The computer system of claim 33, wherein the program further comprises a module to scale a displayed image to a new size with data stored in the cache until the program decodes data corresponding to the new size from the image database.

36. The computer system of claim 33, wherein the program further comprises a module to display and to manipulate one or more of the multiple images, at least one of the multiple images having multiple levels of resolution.

37. The computer system of claim 33, wherein the program further comprises a module to manipulate the displayed images either as a group or individually.

38. A method, comprising:
creating a window, the window being defined by a page description language;
displaying multiple raster graphic images in the window, each of the multiple raster graphic images having a separate data file; and
enabling manipulation of one or more of the multiple raster graphic images displayed in the window.

39. The method of claim 38, further comprising:
displaying one or more of the multiple raster graphic images having a hierarchical structure.

40. The method of claim 45, further comprising:
displaying one or more of the multiple raster graphic images having multiple levels of resolution.

41. The method of claim 38, wherein one or more of the multiple raster graphic images comprise a raster graphic image that was compressed according to a block based integer wavelet transform coding scheme.

42. The method of claim 38, further comprising:
scaling one or more of the multiple raster graphic images to a new size with data stored in a cache until a program decodes data corresponding to the new size.

43. The method of claim 38, further comprising:
displaying a representation of an object in the window when a value is below a predetermined setting and displaying the object in the window when the value is above the predetermined setting.

44. An apparatus, comprising:
means for creating a window defined by a page description language; means for displaying multiple raster graphic images in the window, each of the multiple raster graphic images having a separate data file; and
means for enabling manipulation of one or more of the multiple raster graphic images displayed in the window.

45. The apparatus of claim 44, wherein one or more of the multiple raster graphic images have a hierarchical structure.

46. The apparatus of claim 44, wherein one or more of the multiple raster graphic images have multiple levels of resolution.

47. The apparatus of claim 44, wherein one or more of the multiple raster graphic images was compressed according to a block based integer wavelet transform coding scheme.

48. The apparatus of claim 44, further comprising:
means for scaling one or more of the multiple raster graphic images to a new size with data stored in a cache until a program decodes data corresponding to the new size.

49. The apparatus of claim 44, further comprising:
means for displaying a representation of an object in the window when a value is below a predetermined setting and displaying the object in the window when the value is above the predetermined setting.

50. The apparatus of claim 44, further comprising:
means for displaying multiple images at different resolution levels in the window.
